(19) United States
(12) Patent Application Publication
(10) Pub. No.: US 2002/0065118 A1
(43) Pub. Date: May 30, 2002

(54) Radio set

(76) Inventors: Norimichi Chiba, Hino-shi (JP); Takashi Amano, Soka-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/995,826

(22) Filed: Nov. 29, 2001

(30) Foreign Application Priority Data
Nov. 30, 2000 (JP) 2000-365518

(51) Int. Cl. H04B 1/38

(52) U.S. Cl. 455/575; 455/90; 455/347

(57) ABSTRACT

A radio set comprises an antenna which is a λ/2 monopole antenna capacitively coupled to the radio circuit on a circuit substrate by way of a capacitor and powered by the circuit. A ground pattern is formed on the circuit substrate in a region of about λ/2 at the side of the antenna as viewed in the axial direction of the antenna and another ground pattern is formed in the remaining region of about λ/2 and electrically connected to the ground pattern by way of an inductor. The inductance of the inductor is so selected that the phase of the electric current flowing between the ground pattern and the ground pattern is advanced by 180° at the operating frequency of the wavelength λ.

### CROSS-REFERENCE TO RELATED APPLICATIONS

This application is based upon and claims the benefit of priority from the prior Japanese Patent Application No. 2000-365518, filed Nov. 30, 2000, the entire contents of which are incorporated herein by reference.

### BACKGROUND OF THE INVENTION

1. Field of the Invention

This invention relates to a radio set that can be used for various mobile communication systems including mobile telephone systems.

2. Description of the Related Art

FIG. 9 of the accompanying drawings schematically illustrates the positional relationship between the antenna 100 and the circuit substrate 200 of a typical known mobile phone set that can be used for various mobile communication systems including mobile telephone systems.

More specifically, FIG. 9 shows a radio set comprising an antenna 100 which is a λ/2 monopole antenna capacitively coupled to the radio circuit on the circuit substrate 200 by way of a capacitor 110 and powered by the circuit.

Such a radio set provides a radiation pattern shown in FIG. 10, as viewed in a direction perpendicular to the axis of the antenna 100, the front end of the antenna 100 being in the direction of 0°.

By comparing FIGS. 9 and 10, it will be appreciated that the axis running through 0° and ±180° and the one running through −90° and +90° in FIG. 10 respectively correspond to the x-axis and the y-axis in FIG. 10.

As seen from the radiation pattern, the radiation pattern of the known radio set involves null directions. In the case of FIG. 10, the directions of 120° and −120° are null directions.

The electric current I1 generated in the antenna 100 and the electric currents I2 and I3 generated in the circuit substrate 200 are responsible for the nulls. The arrows indicating the respective electric currents in FIG. 9 also show the phase relationships among the electric currents.

The phase of the electric current I1 generated in the antenna 100 and that of the electric current I3 generated in the circuit substrate 200 are inverted relative to each other so that the desired electric wave radiation by the electric current I1 and the electric wave radiation by the electric current I3 offset each other to produce the nulls.

Such nulls reduce both the signal reception level and the quality of the received signals to make it difficult to maintain the intended quality level for the received signals.

Most conventional radio sets generates a radiation pattern having nulls. Their reception levels fall, depending on the direction in which the target radio waves are coming. Due to the low reception levels, the conventional radio sets cannot have desired signal-receiving characteristics.

### BRIEF SUMMARY OF THE INVENTION

A radio set according to an aspect of the invention comprises:

an antenna for transmitting radio signals and receiving radio signals;

a circuit substrate comprising a radio circuit for transmitting and receiving radio signals; and

a plurality of ground patterns provided on the circuit substrate,

the ground patterns being electrically connected by connection means, so as to generate electric currents which have the same phase as an electric current generated in the antenna,

the connection means being arranged to cause an electric current to flow, which has a phase opposite to the phase of the electric current generated in the antenna.

With a radio set according to the invention and having the above described configuration, as pointed out above, a plurality of ground patterns are arranged on the circuit substrate and connected to one another by connection means so as to generate an electric current with a phase the same as that of the electric current generated in the antenna, and the connection means are arranged so as to cause an electric current to flow with a phase inverted relative to that of the electric current generated in the antenna.

A radio set according to an aspect of the invention comprises:

an antenna for transmitting radio signals and receiving radio signals; and

a circuit substrate comprising a ground pattern and a radio circuit for transmitting and receiving radio signals;

the ground pattern having a notch at a position where an electric current having a phase opposite to the phase of the electric current generated in the antenna is likely to be generated, the notch extending perpendicularly to the direction in which the electric current generated in the antenna flows, so as not to generate an electric current having a phase opposite to the phase of the electric current generated in the antenna.

As pointed out above, with a radio set according to the invention and having the above described configuration, the ground pattern of the circuit substrate is provided at a position apt to generate an electric current with a phase inverted relative to that of the electric current generated in the antenna with a notch directed perpendicularly relative to the direction of the flow of the electric current generated in the antenna so as not to generate an electric current with a phase inverted relative to that of the electric current generated in the antenna.

A radio set according to an aspect of the invention comprises:

an antenna for transmitting radio signals and receiving radio signals; and

a circuit substrate comprising a ground pattern and a radio circuit for transmitting and receiving radio signals;

the ground pattern having a projection at a position where an electric current having a phase opposite to the phase of the electric current generated in the antenna is likely to be generated, the projection extending perpendicularly to the direction in which the electric current generated in the antenna flows, so as not to generate an electric current having a phase opposite to the phase of the electric current generated in the antenna.

As pointed out above, with a radio set according to the invention and having the above described configuration, the ground pattern of the circuit substrate is provided at a position apt to generate an electric current with a phase inverted relative to that of the electric current generated in the antenna with a projection directed perpendicularly relative to the direction of the flow of the electric current generated in the antenna so as not to generate an electric current with a phase inverted relative to that of the electric current generated in the antenna.

A radio set according to an aspect of the invention comprises:

an antenna for transmitting radio signals and receiving radio signals;

a circuit substrate comprising a radio circuit for transmitting and receiving radio signals;

a first ground pattern provided on the circuit substrate;

a second ground pattern provided on the circuit substrate; and

connection means for electrically connecting the first and second ground patterns, so as to make that electric currents flowing through the first and second ground patterns have the same phase as the electric current generated in the antenna.

With a radio set according to the invention and having the above described configuration, the first ground pattern and the second ground pattern are electrically connected to each other by connection means so as to make both the phase of the electric current flowing through the first ground pattern and that of the electric current flowing through the second ground pattern the same as that of the phase of the electric current generated in the antenna.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic circuit block diagram of the first embodiment of a radio set according to the invention;

FIG. 2 is a schematic illustration of the radiation pattern of the antenna of the radio set of FIG. 1;

FIG. 3 is a schematic circuit block diagram of the second embodiment of a radio set according to the invention;

FIG. 4 is a schematic circuit block diagram of an embodiment of a radio set according to the invention obtained by modifying the embodiment of FIG. 3 and substantially as effective as the embodiment of FIG. 3;

FIG. 5 is a schematic circuit block diagram of another embodiment of a radio set according to the invention also obtained by modifying the embodiment of FIG. 3 and substantially as effective as the embodiment of FIG. 3;

FIG. 6 is a schematic circuit block diagram of the third embodiment of radio set according to the invention;

FIG. 7 is a schematic circuit block diagram of an embodiment of a radio set according to the invention obtained by modifying the embodiment of FIG. 6 and substantially as effective as the embodiment of FIG. 6;

FIG. 8 is a schematic circuit block diagram of another embodiment of a radio set according to the invention also obtained by modifying the embodiment of FIG. 6 and substantially as effective as the embodiment of FIG. 6;

FIG. 9 is a schematic circuit block diagram of a known radio set; and

FIG. 10 is a schematic illustration of the radiation pattern of the antenna of the radio set of FIG. 9.

### DETAILED DESCRIPTION OF THE INVENTION

Now, the present invention will be described in greater detail by referring to the accompanying drawings that illustrate preferred embodiments of the invention.

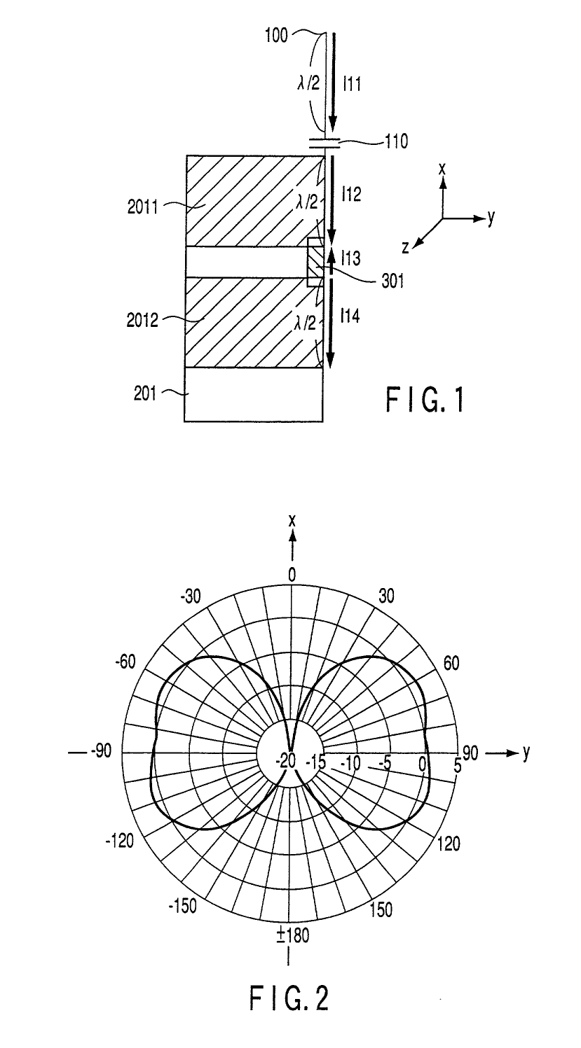

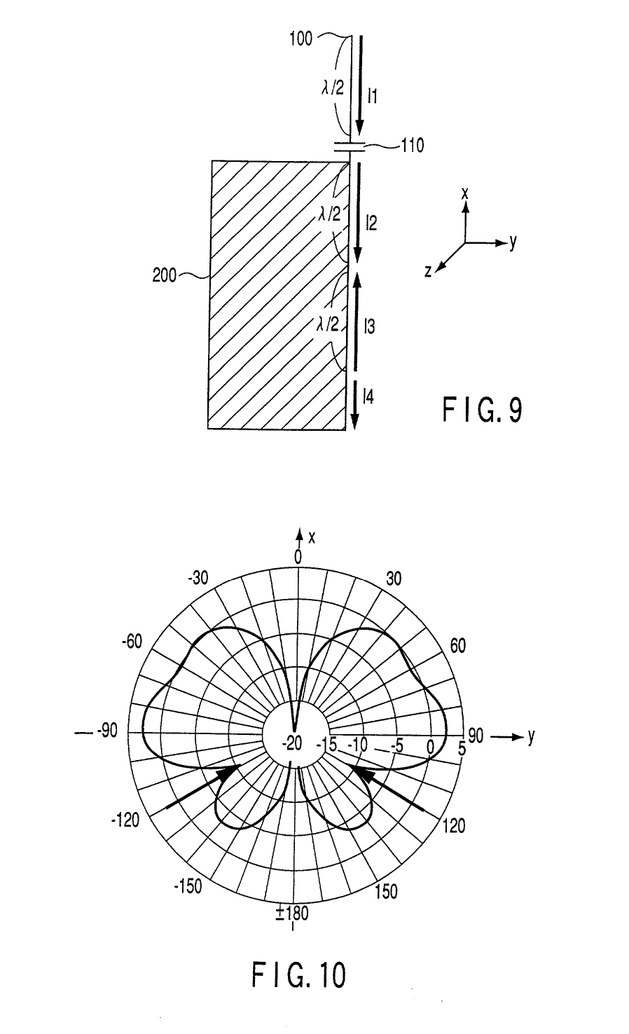

FIG. 1 is a schematic circuit block diagram of the first embodiment of the radio set according to the invention. In FIG. 1, the components the same as those of the known radio set of FIG. 9 are denoted respectively by the same reference symbols. The embodiment will be described in terms of the configuration that affects the radio wave radiation pattern.

The radio set of FIG. 1 comprises an antenna 100 which is a λ/2 monopole antenna capacitively coupled to the radio circuit on a circuit substrate 201 by way of a capacitor 110 and powered by the circuit.

A ground pattern 2011 is formed on the circuit substrate 201 in a region of about λ/2 at the side of the antenna 100 as viewed in the axial direction of the antenna 100, and another ground pattern 2012 is formed in the remaining region of about λ/2 and electrically connected to the ground pattern 2011 by way of an inductor 301.

Note that λ denotes the wavelength at the operating frequency of the circuit substrate 201. The inductance of the inductor 301 is so selected that the phase of the electric current flowing between the ground pattern 2011 and the ground pattern 2012 is advanced by 180° at the operating frequency.

With the above described arrangement, both the phase of the electric current I12 generated in the ground pattern 2011 and that of the electric current I14 generated in the ground pattern 2012 are the same as that of the electric current I11 generated in the antenna 100 and hence only the electric current I13 flowing through the inductor 301 shows a phase inverted relative to that of the electric current I11.

Thus, in the radio set having the above described configuration, an inductor 301 is arranged between the two ground patterns 2011, 2012 on the circuit substrate 201 in such a way that the phase of the electric current flowing between the ground patterns 2011, 2012 is inverted, or advanced by 180°, and the length of the route through which the electric current I13 whose phase is inverted relative to that of the electric current I11 flows is minimized.

Therefore, the route in which the current I13 opposite in phase to the current I11 flows is short in the radio set described above. The component of the current I11, which offsets the radio-wave radiation, decreases, reducing the nulls in the radiation pattern as shown in FIG. 2. Thanks to the reduction of nulls, the radio set can exhibit good signal-receiving characteristics.

The present invention is by no means limited to the above described embodiment. For example, while an inductor 301 is arranged in the above embodiment for the purpose of phase inversion, the inductor 301 may be replaced by a capacitor for phase inversion.

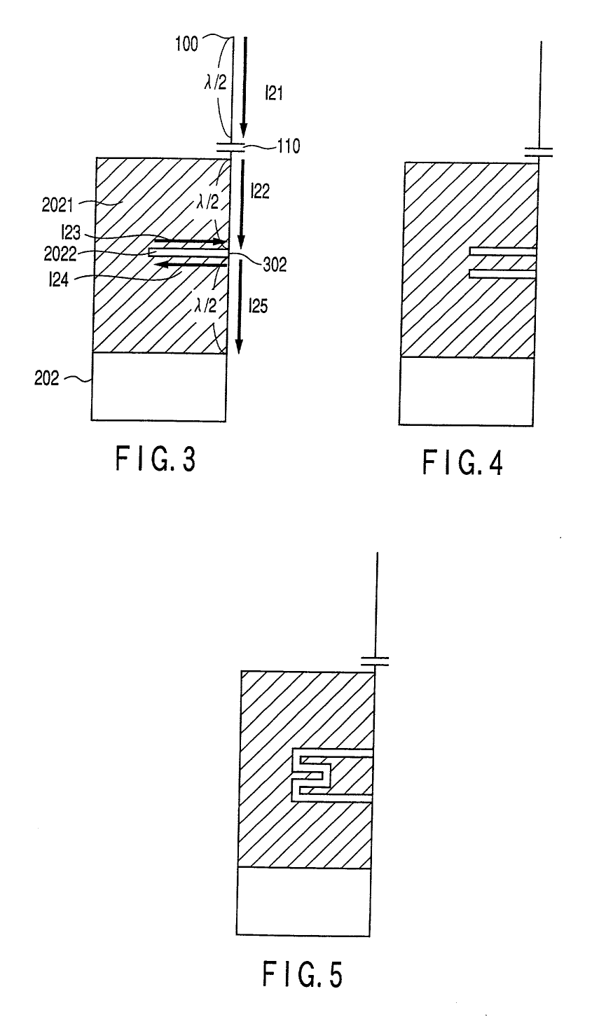

Now, the second embodiment of radio set according to the invention will be described. FIG. 3 is a schematic circuit block diagram of the second embodiment.

In FIG. 3, the components the same as those of the known radio set of FIG. 9 are denoted respectively by the same reference symbols. The embodiment will be described in terms of the configuration that affects the radio wave radiation pattern.

The radio set of FIG. 3 comprises an antenna 100 which is a λ/2 monopole antenna capacitively coupled to the radio circuit on a circuit substrate 202 by way of a capacitor 110 and powered by the circuit.

A ground pattern 2021 having a notch 2022 directed perpendicularly relative to the axial direction of the antenna 100 is formed on the circuit substrate 202.

Note that the notch 2022 is formed at the position 302 separated by a distance of λ/2 from both of the opposite ends of the ground pattern 2021 as viewed in the axial direction of the antenna 100.

Also note that λ denotes the wavelength at the operating frequency of the circuit substrate 202.

With the above described arrangement, both the phase of the electric current I22 generated in a region of the ground pattern located close to the antenna 100 relative to the notch 2022 and that of the electric current I25 generated in a region of the ground pattern remote from the antenna 100 relative to the notch 2022 are the same as that of the electric current I21 generated in the antenna 100 and the electric currents I23, I24 that flow along the notch 2022 are directed perpendicularly relative to the axis of the antenna 100.

Thus, in the radio set having the above described configuration, the circuit substrate 202 is provided with a notch 2022 at the position 302 equally dividing the circuit substrate 202 into two parts showing a length of λ/2 in order to prevent any electric current showing a phase inverted relative to that of the electric current I1 from being generated.

No current that is opposite in phase to the current I1 is generated in the radio set so constructed as described above. This reduces the number of nulls in the radiation pattern. As a result, the radio set has desirable signal-receiving characteristics.

The present invention is by no means limited to the above described embodiment. For example, while the notch formed in the circuit substrate 202 may be replaced by a pair of notches as shown in FIG. 4, or a notch as shown in FIG. 5, to provide a similar effect of preventing any electric current showing a phase inverted relative to that of the electric current I1 from being generated.

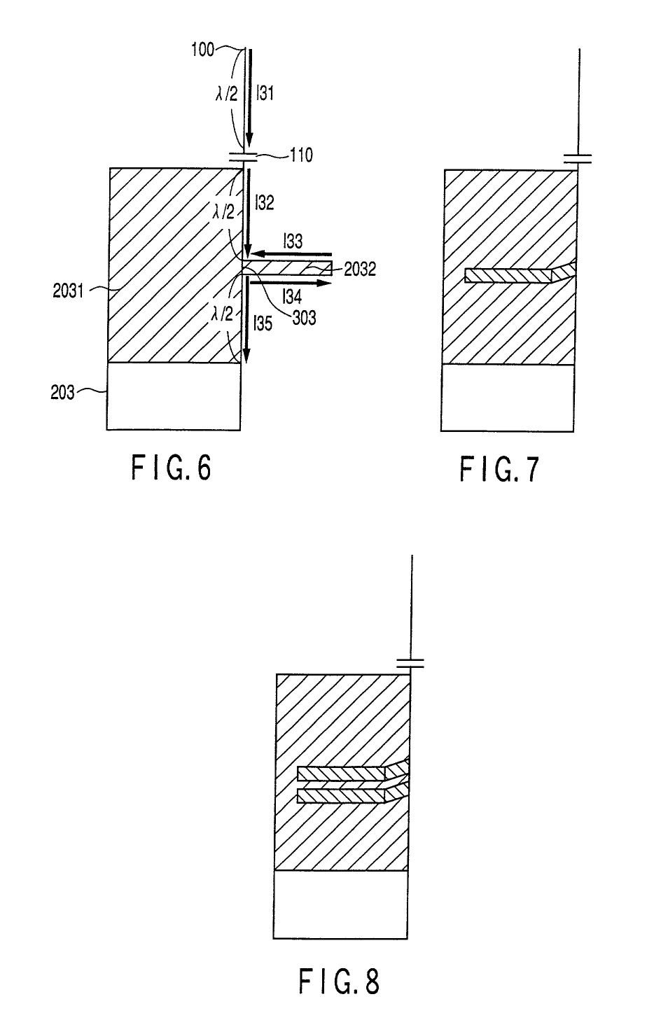

Now, the third embodiment of a radio set according to the invention will be described. FIG. 6 is a schematic circuit block diagram of the second embodiment.

In FIG. 6, the components the same as those of the known radio set of FIG. 9 are denoted respectively by the same reference symbols. The embodiment will be described in terms of the configuration that affects the radio wave radiation pattern.

The radio set of FIG. 6 comprises an antenna 100 which is a λ/2 monopole antenna capacitively coupled to the radio circuit on a circuit substrate 203 by way of a capacitor 110 and powered by the circuit.

A ground pattern 2031 having a projection 2032 directed perpendicularly relative to the axial direction of the antenna 100 is formed on the circuit substrate 203.

Note that the projection 2032 is formed at the position 303 separated by a distance of λ/2 from both of the opposite ends of the ground pattern 2031 as viewed in the axial direction of the antenna 100.

Also note that λ denotes the wavelength at the operating frequency of the circuit substrate 203.

With the above described arrangement, both the phase of the electric current I23 generated in a region of the ground pattern located close to the antenna 100 relative to the projection 2032 and that of the electric current I35 generated in a region of the ground pattern remote from the antenna 100 relative to the projection 2032 are the same as that of the electric current I31 generated in the antenna 100 and the electric currents I33, I34 that flow along the projection 2032 are directed perpendicularly relative to the axis of the antenna 100.

Thus, in the radio set having the above described configuration, the circuit substrate 202 is provided with a projection 2032 at the position 303 equally dividing the circuit substrate 202 into two parts showing a length of λ/2 in order to prevent any electric current showing a phase inverted relative to that of the electric current I1 from being generated.

No current that is opposite in phase to the current I1 is generated in the radio set so constructed as described above. This reduces the number of nulls in the radiation pattern. As a result, the radio set acquires good signal-receiving characteristics.

The present invention is by no means limited to the above described embodiment. For example, while the projection formed in the circuit substrate 203 may be folded onto the circuit substrate 203 as shown in FIG. 7 or replaced by a pair of projections as shown in FIG. 8 that may or may not be folded onto the circuit substrate 203, so long as such a projection or projections can provide a similar effect of preventing any electric current showing a phase inverted relative to that of the electric current I1 from being generated.

The present invention is not limited to the above described embodiments.

For example, while the notch 2022 and the projection 2032 of the above described embodiments are made to extend in a direction perpendicular to the axis of the antenna 100, they may not be arranged strictly in a perpendicular direction to the axis of the antenna 100 so long as they provide a similar effect.

Furthermore, the above described embodiments may be modified and/or altered appropriately without departing from the scope of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio set comprising:
an antenna for transmitting radio signals and receiving radio signals;
a circuit substrate comprising a radio circuit for transmitting and receiving radio signals; and
a plurality of ground patterns provided on said circuit substrate,
said ground patterns being electrically connected by connection means, so as to generate electric currents which have the same phase as an electric current generated in said antenna,
said connection means being arranged to cause an electric current to flow, which has a phase opposite to the phase of the electric current generated in said antenna.

2. The radio set according to claim 1, wherein
said connection means is an inductor.

3. The radio set according to claim 1, wherein
said connection means is a capacitor.

4. A radio set comprising:
an antenna for transmitting radio signals and receiving radio signals; and
a circuit substrate comprising a ground pattern and a radio circuit for transmitting and receiving radio signals;
said ground pattern having a notch at a position where an electric current having a phase opposite to the phase of the electric current generated in said antenna is likely to be generated, said notch extending perpendicularly to the direction in which the electric current generated in said antenna flows, so as not to generate an electric current having a phase opposite to the phase of the electric current generated in said antenna.

5. A radio set comprising:
an antenna for transmitting radio signals and receiving radio signals; and
a circuit substrate comprising a ground pattern and a radio circuit for transmitting and receiving radio signals;
said ground pattern having a projection at a position where an electric current having a phase opposite to the phase of the electric current generated in said antenna is likely to be generated, said projection extending perpendicularly to the direction in which the electric current generated in said antenna flows, so as not to generate an electric current having a phase opposite to the phase of the electric current generated in said antenna.

6. A radio set comprising:
an antenna for transmitting radio signals and receiving radio signals;
a circuit substrate comprising a radio circuit for transmitting and receiving radio signals;
a first ground pattern provided on said circuit substrate;
a second ground pattern provided on said circuit substrate; and
connection means for electrically connecting the first and second ground patterns, so as to make that electric currents flowing through said first and second ground patterns have the same phase as the electric current generated in said antenna.

7. The radio set according to claim 6, wherein
said connection means is an inductor.

8. The radio set according to claim 6, wherein said connection means is a capacitor.
